(19) United States
(12) Patent Application Publication
(10) Pub. No.: US 2009/0251294 A1
(43) Pub. Date: Oct. 8, 2009

(54) ARTICLE MANAGEMENT SYSTEM AND ARTICLE MANAGEMENT METHOD

(76) Inventors: Masao Kawamura, Tokyo (JP); Kou Takesaki, Tokyo (JP); Kentaro Yamasaki, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 12/295,564

(22) PCT Filed: Mar. 30, 2007
(86) PCT No.: PCT/JP2007/057723

§ 371 Date: Sep. 30, 2008

(30) Foreign Application Priority Data
Mar. 30, 2006 (JP) 2006-094752

(51) Int. Cl. H04Q 5/22

(52) U.S. Cl. 340/10.51

(57) ABSTRACT

As an assembly 50 of articles of management targets, a serial number that becomes a consecutive number is recorded in each of RFID tags 1, 2, . . . , 12 attended to cardboard boxes 31, 32, . . . , 42 in which articles are stored and a flag, by which the total number of articles that becomes a management target of articles can be calculated, is recorded in at least one of RFID tags. For example, the serial numbers are consecutive numbers starting from one, and the total number of articles is recorded in the flags of all of the RFID tags, or an end flag indicating the last is recorded in the flag of the last RFID tag. The serial numbers are consecutive numbers starting an arbitrary number, a start flag indicating the first is recorded in the flag of the first RFID tag and an end flag indicating the last is recorded in the flag of the last RFID tag, or the total number is recorded in the flag of the last RFID tag.

### TECHNICAL FIELD

The present invention relates to an electronic tag attached target management system, an article management system, a lending management system, an entering and leaving management system, a management method and an electronic tag, and particularly, the present invention relates to an electronic tag attached target management system, an article management system, a lending management system, an entering and leaving management system, a management method and an electronic tag capable of reading confirmation of RFID (Radio Frequency Identification) tags for management of articles, the number of people on entering and leaving of an institution, lending/return of articles and the like. For example, the present invention can be suitably applied to all of physical distribution management from part manufacturing to apparatus assembly, arrival and shipment management for articles, inventory management for an article warehouse and arrival and shipment inspection work in a physical distribution chain up to wholesale and retail of articles.

### BACKGROUND ART

In recent years, for physical distribution management such as arrival and shipment or transportation of articles, the case of using a two-dimensional bar code or an RFID tag is increased. For example, in Prior Art Document 1 (Japanese Patent Application Publication No. 2002-087532 (pp. 4 to 7)), article information, shipment information and the like are written onto a surface of a rewritable data carrier as a two-dimensional bar code, and simultaneously the same information is written into an RFID tag that exists in the data carrier. This data carrier is attached to a container in which articles are stored, and the articles are confirmed at arrival and shipment of the articles by reading the two-dimensional bar code on the surface of the data carrier. In the case where the two-dimensional bar code cannot be read, the RFID tag is to be read.

### DISCLOSURE OF THE INVENTION

### Problems to be Solved by the Invention

In an article management field such as physical distribution management of articles, a demand to carry out package inspection, such as for confirming whether or not all of a plurality of articles are arrived or shipped, or whether or not there is an inventory of the necessary pieces of articles, at a time is strong. Here, in the case where application to a physical distribution field, such as for managing arrival and shipment of the plurality of articles at a time, is considered, it is necessary for a bar code reader to be closely arranged in the vicinity of respective bar code tags in the form of application of the bar code tag, and it cannot be implemented for package management. On the other hand, an RFID tag uses radio waves, and a reader/writer arranged within a certain level of range can collectively receive the radio waves transmitted from the respective RFID tags. Therefore, by attaching an RFID tag to each of the plurality of articles and reading the RFID tags of the plurality of articles at a time, it is possible to confirm whether or not all of the plurality of articles are arrived or shipped.

However, in the case where the number of the plurality of articles is not seen in advance and there is any article whose RFID tag could not be read, the fact that it could not be read itself is not seen, only the articles that could be read are subjected to inspection, and inspection work becomes imperfect. For this reason, in the case where it is applied to package inspection, it could be used so long as there is no reading error of the RFID tag and reading accuracy is 100%.

More specifically, when a plurality of articles are caused to collectively arrive with an RFID tag attached to each of the plurality of articles of which the total number is not seen, for example, arrival inspection cannot be carried out accurately because the fact that it could not be read itself is not seen in the case where the package inspection is carried out by reading the plurality of RFID tags together at a time by means of a gate system (gate mechanism) or the like and there is any RFID tag that could not be read. Since the reading accuracy must always be 100% in order to carry out arrival inspection accurately, it must be read by a handy type reader/writer in place of the gate system. Reading time differs little from that in the case of the bar code, and it is unsuitable for package management.

For this reason, if reading accuracy of RFID tags is less than 100%, shipment data and arrival data must be prepared as a shipment list in advance, and the number of a plurality of articles to be subjected to inspection must be confirmed every time by being compared with the shipment data and arrival data prepared in advance in every package inspection work. For example, in the case of using a gate system for carrying out arrival inspection, it is necessary to confirm whether or not all can be read by the gate system every time by acquiring a shipment list in advance and being compared with the shipment list. Therefore, wasted time is required.

Alternatively, in the case where the shipment data or arrival data cannot be acquired in advance, another RFID tag is attached to a palette or the like on which articles are loaded in addition to the RFID tags attached to the articles; it is always read by a handy type reader/writer or the like; the number of articles loaded on the palette is confirmed; and package inspection work then needs to be carried out. More specifically, in the case where the plurality of articles are loaded on the palette, the total number thereof is written into another RFID tag, the RFID tag is to be attached to the palette, and the RFID tag attached to the palette first needs to be read by the handy type reader/writer before the package inspection is carried out at a side of arrival of articles. However, the total number of articles can be seen by reading this RFID tag, but an extra RFID tag must be attached to the palette at a side of shipment of articles, and a work to read this RFID tag by the handy type reader/writer every time is generated at a side of arrival of articles. For this reason, there is a problem that the work is extremely inefficient.

Moreover, even when a plurality of RFID tags respectively attached to a plurality of articles in which the number of shipments and the number of arrivals are not seen to carry out package inspection, it is unknown whether any RFID tag that could not be read exists or not. Further, in the case where any RFID tag could not be read, it cannot be known where the RFID tag that could not be read is positioned.

Further, in a lending service of equipment such as tools and medical devices, after lending, for example, a set of tools as lending target items, normally, check on all of the set of lent tools at return is confirmed by a hand work while looking data of the lending target items registered in a PC at lending and the returned tools. However, a good deal of omission of registration, omission of confirmation and the like occur due to a hand work, and accurate confirmation cannot often be made.

Further, in the case of managing entering and leaving by means of a roll call in a group of a child educational institution such as kindergarten and a nursery school, a nursing home and the like, a group management subject (for example, a children's nurse in the case of kindergarten) normally makes a roll call, by which confirmation of the number of people is carried out. However, since this confirmation of the number of people is carried out by means of the roll call of the group management subject, mistake such as omission of confirmation may occur, and accurate confirmation cannot often be made.

Moreover, by acquiring IDs of the RFID tags when the RFID tag described above is utilized for an inspection work, package inspection becomes possible, but it is not always true that all IDs of the RFID tags can be acquired by 100%. Further, a plurality of lots divided for every delivery shop or every product kind normally exist in articles to be subjected to inspection.

If an inspection operator can know which article of a lot to which an RFID tag is attached it fails to read when a miss in reading occurs, reinspection under a situation in which collision is controlled by leaving only the articles in the lot in which the miss in reading occurred. Further, by terminating inspection for the lot for which all of the RFID tags attached to the articles could be confirmed, efficiency of the inspection work can be achieved.

However, inasmuch as determination of a miss in reading in a lot unit cannot be made heretofore, it was necessary to acquire IDs for the whole again when a miss in reading occurred.

The present invention is made in consideration of the circumstances described above, and it is an object of the present invention to provide an electronic tag attached target management system, an article management system, a lending management system, an entering and leaving management system, a management method and an electronic tag as an RFID tag package reading system for reading a plurality of RFID tags attached to articles, lending target items, institution users and the like, the total number of which is unknown, at a time and at the same time, which writes writing data into the RFID tags in accordance with specific rules; and specifies the total inspection number, the total number of lending target items, the number of institution users, and a serial number of the RFID tag that cannot be read from data of the RFID tags read for confirmation of the articles and the like, by which it is possible to specify the corresponding articles and the like.

### Means for Solving the Problems

In order to solve the problems described above, the present invention adopts the following configurations.

An electronic tag attached target management system according to a first aspect of the present invention is an electronic tag attached target management system for managing attached targets using electronic tags respectively attached to the attached targets, the electronic tag attached target management system including a data writing apparatus for recording a serial number in each of the electronic tags and for recording a flag in at least one of the electronic tags, the serial numbers being consecutive numbers, the total number of attached targets being able to be calculated by means of the flag.

An article management system according to a second aspect of the present invention is an article management system for managing articles using RFID tags attached to the respective articles, the article management system including a data writing apparatus for recording a serial number in each of the RFID tags and for recording a flag in at least one of the RFID tags, the serial numbers being consecutive numbers, the total number of articles that become management targets of the articles being able to be calculated by means of the flag.

An article management method according to a third aspect of the present invention is an article management method of managing articles using RFID tags attached to the respective articles, wherein the method includes recording a serial number in each of the RFID tags, the serial numbers being consecutive numbers, and recording a flag in at least one of the RFID tags, the total number of articles that become management targets of the articles being able to be calculated by means of the flag.

A lending management method according to a fourth aspect of the present invention is a lending management method of managing lending using RFID tags attached to respective lending target articles, the lending management method including: recording serial numbers that are consecutive numbers in the respective RFID tags; and recording a flag in at least one of the RFID tags, the total number of articles that become management targets being able to be calculated by means of the flag.

An entering and leaving management method according to a fifth aspect of the present invention is an entering and leaving management method of managing entering and leaving in an institution using RFID tags attached to respective visitors, the entering and leaving management method including: recording a serial number in each of the RFID tags, the serial numbers being consecutive numbers; and recording a flag therein, the total number of articles that become management targets being able to be calculated by means of the flag.

A method of preventing a miss in reading according to a sixth aspect of the present invention includes: a first step of generating miss-in-reading preventing information; a second step of storing the generated miss-in-reading preventing information in an RFID tag attached to an inspection target object; a third step of acquiring a pair of all tag IDs belonging to the same lot and the stored miss-in-reading preventing information for every lot; a fourth step of creating a first list, the first list having the pair of the acquired all tag IDs and the acquired miss-in-reading preventing information as elements; a fifth step of acquiring one piece of miss-in-reading preventing information from the first list; a sixth step of extracting an element having the same miss-in-reading preventing information as the acquired miss-in-reading preventing information from the first list and of creating a second list having a tag ID as an element, the tag ID pairing with the extracted miss-in-reading preventing information; a seventh step of calculating the miss-in-reading preventing information on the basis of the second list; and an eighth step of checking and comparing the acquired miss-in-reading preventing information with the calculated miss-in-reading preventing information and of determining that all of the tags stored in the first list and the articles of an assigned lot get together in the case that they are equal to each other.

An electronic tag according to a seventh aspect of the present invention is an electronic tag used with a predetermined number of lots, the electronic tag including: a first storage section that stores first information for identifying whether the predetermined number of lots exist or not.

### EFFECTS OF THE INVENTION

According to the present invention, in package inspection of an assembly of a plurality of articles, there is no need to acquire a shipment slip or the like from a side of shipment of articles, and the total number of arrived articles can be seen by reading RFID tags even when the total number of the plurality of articles included in the assembly is unknown at a side of arrival of articles. The reason is that information by which the total number of articles can be calculated is recorded in the read RFID tags.

Further, according to the present invention, it is possible to specify the number of RFID tags that could not be read and the articles corresponding to the RFID tags that could not be read without the shipment slip or the like at the package inspection of the articles. The reason is that it is possible to specify the corresponding missing parts from the serial numbers that could not be read because a series of serial numbers is recorded in the RFID tags.

Moreover, according to the present invention, by describing the serial numbers and the flags in the tag and causing item storage cases to pass through the gate, which is the inspection apparatus for the lending target items, at return, it is possible to quickly confirm whether or not the lending target items get together without mislaid.

Furthermore, according to the present invention, by causing the group management subjects to pass through the gate in turn, a quick roll call and confirmation are completed. In addition, the group management subjects carry the handy type reader/writer, by which the similar function can be achieved at an outside location.

According to the present invention, the miss-in-reading preventing information storage means is caused to store the miss-in-reading preventing information on the RFID tags in a lot unit at shipment. This miss-in-reading preventing information is hash data created with hash algorithm on the basis of the IDs of all RFID tags belonging to the same lot. By causing the tag to store the hash data based on the IDs of all RFID tags belonging to the same lot as the miss-in-reading preventing information, it not only functions as an identifier for every lot, determination of a miss in reading is but also possible by taking a step of creating the hash data on the basis of the IDs of the tags whose miss-in-reading preventing information is the same at inspection, and a step of comparing them.

### BRIEF DESCRIPTION OF THE DRAWING

FIG. 1 is a schematic view showing an example of a state of an assembly of articles to subjected to package inspection in an article management system according to the present invention;

FIG. 2 is a schematic view showing a gate type inspection system for carrying out package inspection for an assembly of articles at a side of arrival of articles;

FIG. 3 is a schematic view showing a data writing apparatus for writing data for management of articles into an assembly 50 of articles at a side of shipment of articles;

FIG. 4 is a table for explaining an example of data to be written for management of articles into an RFID tag attached to each cardboard box in a data writing apparatus at the side of shipment of articles;

FIG. 5 is a screen display view showing an example that is displayed on a display device at the side of arrival of articles as an article inspection result;

FIG. 6 is a table for explaining another example of data to be written for management of articles into an RFID tag attached to each cardboard box in a data writing apparatus at the side of shipment of articles;

FIG. 7 is a screen display view showing a screen display example in the case where a last RFID tag in which an end flag (E) is recorded cannot be read;

FIG. 8 is a table for explaining still another example of data to be written for management of articles into an RFID tag attached to each cardboard box in a data writing apparatus at the side of shipment of articles;

FIG. 9 is a table for explaining still another example of data to be written for management of articles into an RFID tag attached to each cardboard box in a data writing apparatus at the side of shipment of articles;

FIG. 10 is a screen display view showing a screen display example in the case where a last RFID tag in which an end flag (E) is recorded cannot be read;

FIG. 11 is a view showing a configuration of a lending management system on lending of equipment such as tools and medical devices;

FIG. 12 is a view showing a state where item storage cases are caused to pass through a gate on return;

FIG. 13 is a view showing a configuration of an entering and leaving management system for managing entering and leaving of a group;

FIG. 14 is a block diagram showing a configuration of an RFID tag according to another embodiment of the present invention;

FIG. 15 is a block diagram showing a configuration of an RFID tag operating apparatus according to another embodiment of the present invention;

FIG. 16 is a flowchart showing process steps from generation of miss-in-reading preventing information to storage to an RFID tag attached to an article, which miss-in-reading preventing information generating means of an RFID tag operating apparatus carries out on shipment; and

FIG. 17 is a flowchart for explaining a process step for determining whether or not there is a miss in reading of RFID tags respectively attached to articles in the same lot, which miss-in-reading confirming means of the RFID tag operating apparatus carries out on inspection.

### BEST MODE FOR CARRYING OUT THE INVENTION

Hereinafter, embodiments of the present invention will be described with reference to the drawings.

Hereinafter, embodiments of an article management system, a method, a lending management system, and an entering and leaving management system according to the present invention will be described with reference to the drawings.

Features of the present invention will first be described. The present invention provides an effective mechanism for managing deficiency of articles and the like on shipment, arrival, transportation, inventory management and the like of articles, and can be suitably applied to an RFID tag package reading system that can grasp the total number and acquire presence or absence of the deficiency by attaching RFID tags to articles, and reading the RFID tags respectively attached to the plurality of articles at a time even when the total number of articles that are targets cannot be seen.

Here, a feature of the present invention is to provide a mechanism by which the total number of articles that are management targets can be seen by recording data to be recorded in the RFID tags on the basis of predetermined specific rules even when any RFID tag that cannot be read exists, it can be seen that an RFID tag that could not be read exists, and the article corresponding to the RFID tag that could not be read can be specified.

Next, some RFID recorded data examples of data to be recorded in an RFID tag on the basis of predetermined specific rules will be described.

First RFID recorded data will first be described. Here, at a side of shipment of articles, it will be assumed that the total number Q of articles to be loaded on an assembly of articles that are subjected to inspection at a time is seen. In this case, for every assembly of articles that is a target of article management, data are recorded in an RFID tag attached to the article in accordance with the following rules. More specifically, a serial number i of a series of consecutive numbers starting from “1” is applied to the RFID tag attached to each article, and the total number Q of loaded articles is record therein. Here, the serial numbers applied to the RFID tags are not limited to those starting from “1”, and predetermined given values may be used.

An RFID tag attached to a first article: a serial number (1), the total number (Q)

An RFID tag attached to a second article: a serial number (2), the total number (Q)

. . .

An RFID tag attached to a Pth article: a serial number (P), the total number (Q)

. . .

An RFID tag attached to a last Qth article: a serial number (Q), the total number (Q)

Inasmuch as the total number Q is recorded in every RFID tag, the total number Q of arrivals can be seen immediately at a side of arrival of articles. For this reason, by confirming the serial numbers i, and checking whether or not the serial numbers are acquired from the first to the last of the serial number i without falling out any serial number, it can be seen whether all of the RFID tags are read or not, or how many RFID tags cannot be read.

In the case where there are some RFID tags that cannot be read, the RFID tags falling out can be specified by confirming the serial numbers i that can be read. For example, in the case where a Pth RFID tag cannot be read, a serial number (P) is to fall out.

In the case of this RFID recorded data, for example, it will be assumed that the total number N of all articles to be shipped from Kanto area to Kansai area at one time and date is seen. An instruction is outputted that Q pieces of the total number N are loaded on a first palette for shipment, and data indicating the total number Q loaded on the palette are transmitted to a handy type reader/writer of a physical distribution department from a host computer with a wireless LAN, for example.

Next, the Q pieces of cardboard boxes in which articles are stored are loaded on the palette. When there becomes a state where an RFID tag is attached to each of the cardboard boxes one by one, the corresponding serial number i and the total number Q are in turn written into the RFID tags attached to the respective cardboard boxes on each palette one by one from “1” by means of the handy type reader/writer. For example, by drawing a check on each of the cardboard boxes attached to the RFID tag in which writing is completed by means of a magic marker, it is possible to prevent omission of writing of data into the RFID tag. Here, there is particularly no limitation on writing order of data into the RFID tags of each of the cardboard boxes and the like. Serial numbers i from “1” may be assigned to the RFID tags of all of the cardboard boxes on the palette in turn, and the total number Q may be written into them as a flag.

Next, second RFID recorded data will be described. Here, at a side of shipment of articles, it will be assumed that the total number N of all articles to be shipped, and the total numbers Q1, Q2, . . . , Qm of articles to be loaded on the respective assemblies of articles that are divided to be inspected at a time are seen. In this case, for every assembly of articles that is a target of article management, data are recorded in an RFID tag attached to the article in accordance with the following rules. More specifically, a series of consecutive numbers of serial numbers i starting from an arbitrary number “j” are applied to the RFID tags attached to the respective articles. A start flag is recorded in a first RFID tag while an end flag is recorded in a last RFID tag.

An RFID tag attached to a first article: a serial number (j), a start flag (S)

An RFID tag attached to a second article: a serial number (j+1), a flag (0)

. . .

An RFID tag attached to a Pth article: a serial number (j+P−1), the flag (0)

. . .

An RFID tag attached to a last Qth article: a serial number (j+Q−1), an end flag (E)

At a side of arrival of articles, the serial number (j) of the first RFID tag can be seen from the start flag (S), and the serial number (j+Q−1) of the last RFID tag can be seen from the end flag (E). For this reason, by confirming the total number Q of arrivals and the serial numbers i, and checking whether or not the serial numbers are acquired from the first to the last of the serial numbers i without falling out any serial number, it can be seen whether all of the RFID tags are read or not, or how many RFID tags cannot be read.

In the case where there are some RFID tags that cannot be read, the RFID tags falling out can be specified by confirming the serial numbers i that can be read.

For example, in the case where a Pth RFID tag cannot be read, a serial number (j+P−1) is to fall out. By subtracting the serial number (j) of the first RFID tag to which the start flag (S) is attached from this serial number (j+P−1) and adding “1” thereto, it can be seen that the Pth RFID tag cannot be read.

In the case where the first RFID tag or the last RFID tag cannot be read, it can be seen that the RFID tag in which the start flag (S) or the end flag (E) is recorded does not exist. Thus, the fact is turned out that the first RFID tag or the last RFID tag cannot be read. In this case, by carrying out package rereading or carrying out reading of the RFID tags one by one by means of a handy type reader/writer, the RFID tag that cannot be read is specified.

In the case of this RFID recorded data, for example, it will be assumed that the total number N of all articles to be shipped from Kanto area to Kansai area at one time and date is seen. An instruction is outputted that Q1 pieces, Q2 pieces, . . . , Qm pieces of the total number N of all articles are respectively loaded on a first palette, a second palette, . . . , mth palette for shipment, and data indicating the total numbers Q1, Q2, . . . , Qm loaded on the respective palettes are transmitted to a handy type reader/writer of a physical distribution department from a host computer with a wireless LAN, for example.

Next, the Q1 pieces of cardboard boxes, the Q2 pieces of cardboard boxes, . . . , and the Qm pieces of cardboard boxes in which articles are stored are loaded on the respective palettes in turn from the first palette. When there becomes a state where RFID tags are attached to the respective cardboard boxes one by one, in a physical distribution department, the corresponding serial number i and the flag (a start flag (S) into a first RFID tag of each palette and an end flag (E) into a last RFID tag thereof) are in turn written into the RFID tags attached to the respective cardboard boxes on each palette one by one by means of the handy type reader/writer for every assembly of articles that become article management targets. Then, for example, by drawing a check or the like on each of the cardboard boxes attached to the RFID tag in which writing is completed by means of a magic marker, it is possible to prevent omission of writing of data into the RFID tag.

Here, there is particularly no limitation on writing order of the serial number i into the RFID tags of each of the cardboard boxes and the like. Serial numbers i may be in turn assigned and written to the RFID tags on all of the cardboard boxes on the first palette from “1” to the total number Q1. The serial numbers i from (Q1+1) following to the last serial number Q1 of the first palette to a serial number (Q1+Q2) corresponding to the total number Q2 may be in turn assigned and written to the RFID tags on the cardboard boxes loaded on the second palette. Thereafter, they may be assigned repeatedly in the same manner.

Next, third RFID recorded data will be described. Here, at a side of shipment of articles, it will be assumed that the total number N of all articles to be shipped, and the total numbers Q1, Q2, . . . , Qm of articles to be loaded on the respective assemblies of articles that are divided to be inspected at a time are seen. In this case, for every assembly of articles that is a target of article management, data are recorded in an RFID tag attached to the article in accordance with the following rules. More specifically, a series of consecutive numbers of serial numbers i starting from an arbitrary number “j” are applied to the RFID tags attached to the respective articles. The total number Q is recorded in a flag of a last RFID tag.

An RFID tag attached to a first article: a serial number (j), a flag (0)

An RFID tag attached to a second article: a serial number (j+1), the flag (0)

. . .

An RFID tag attached to a Pth article: a serial number (j+P−1), the flag (0)

. . .

An RFID tag attached to a last Qth article: a serial number (j+Q−1), the total number (Q)

At a side of arrival of articles, inasmuch as the total number Q is recorded in the last Qth RFID tag as the flag, the total number Q of arrivals can be seen and it can also be seen that it is the last RFID tag. Further, by subtracting the total number Q from a serial number (j+Q−1) of the last RFID tag and adding “1” thereto, the serial number (j) of the first RFID tag can be calculated. For this reason, it is possible to specify the first RFID tag.

By confirming the total number Q of arrivals and the serial numbers i, and checking whether or not the serial numbers are acquired from the first to the last of the serial numbers i without falling out any serial number, it can be seen whether all of the RFID tags are read or not, or how many RFID tags cannot be read. Moreover, in the case where there are some RFID tags that cannot be read, the RFID tags falling out can be specified by confirming the serial numbers i that can be read.

For example, in the case where a Pth RFID tag cannot be read, a serial number (j+P−1) is to fall out. By subtracting the serial number (j) of the first RFID tag from this serial number (j+P−1) and adding “1” thereto, it can be seen that the Pth RFID tag cannot be read.

In the case where the last RFID tag cannot be read, it can be seen that the RFID tag in which the total number Q is recorded as the flag does not exist. Thus, the fact is turned out that the last RFID tag cannot be read. In this case, by carrying out package rereading or carrying out reading of the RFID tags one by one by means of a handy type reader/writer, the RFID tag that cannot be read is specified.

In the case of this RFID recorded data, for example, the total number N of all articles to be shipped from Kanto area to Kansai area at one time and date is seen. An instruction is outputted that Q1 pieces, Q2 pieces, . . . , Qm pieces of the total number N of all articles are respectively loaded on a first palette, a second palette, . . . , mth palette for shipment, and data indicating the total numbers Q1, Q2, . . . , Qm loaded on the respective palettes are transmitted to a handy type reader/writer of a physical distribution department from a host computer with a wireless LAN, for example.

Next, the Q1 pieces of cardboard boxes, the Q2 pieces of cardboard boxes, . . . , and the Qm pieces of cardboard boxes in which articles are stored are loaded on the respective palettes in turn from the first palette. When there becomes a state where RFID tags are attached to the respective cardboard boxes one by one, in a physical distribution department, the corresponding serial number i is in turn written into the RFID tags attached to the respective cardboard boxes on each palette one by one by means of the handy type reader/writer and the total numbers Q1, Q2, . . . , Qm are in turn written into the last RFID tags on each palette, respectively. Then, for example, by drawing a check or the like on each of the cardboard boxes attached to the RFID tag in which writing is completed by means of a magic marker, it is possible to prevent omission of writing of data into the RFID tag.

Here, there is particularly no limitation on writing order of the serial number i into the RFID tags of each of the cardboard boxes and the like. Serial numbers i may be in turn assigned and written to the RFID tags on all of the cardboard boxes on the first palette from “1” to the total number Q1. The serial numbers i from (Q1+1) following to the last serial number Q1 of the first palette to a serial number (Q1+Q2) corresponding to the total number Q2 may be in turn assigned and written to the RFID tags on the cardboard boxes loaded on the second palette. Thereafter, they may be assigned repeatedly in the similar manner.

Next, fourth RFID recorded data will be described. Here, at a side of shipment of articles, it will be assumed that the total number Q of articles to be loaded on an assembly of articles that are subjected to inspection at a time is seen. In this case, for every assembly of articles that is a target of article management, data are recorded in an RFID tag attached to the article in accordance with the following rules. More specifically, a series of consecutive numbers of serial numbers i starting from “1” are applied to the RFID tags attached to the respective articles. An end flag (E) is recorded in a last RFID tag.

An RFID tag attached to a first article: a serial number (1), a flag (0)

An RFID tag attached to a second article: a serial number (2), the flag (0)

. . .

An RFID tag attached to a Pth article: a serial number (P), the flag (0)

. . .

An RFID tag attached to a last Qth article: a serial number (Q), an end flag (E)

At a side of arrival of articles, inasmuch as the end flag (E) is recorded in the last Qth RFID tag as the flag, the total number Q of arrivals can be seen from the serial number (Q) and it can also be seen that it is the last RFID tag.

By confirming the total number Q of arrivals and the serial numbers i, and checking whether or not the serial numbers are acquired from the first to the last of the serial numbers i without falling out any serial number, it can be seen whether all of the RFID tags are read or not, or how many RFID tags cannot be read. In the case where there are some RFID tags that cannot be read, the RFID tags falling out can be specified by confirming the serial numbers i that can be read.

For example, in the case where the Pth RFID tag cannot be read, a serial number (P) is to fall out. It can be seen from this serial number (P) that the Pth RFID tag cannot be read.

In the case where the last RFID tag cannot be read, it can be seen that the RFID tag in which the end flag (E) is recorded does not exist. Thus, the fact is turned out that the last RFID tag cannot be read. In this case, by carrying out package rereading or carrying out reading of the RFID tags one by one by means of a handy type reader/writer, the RFID tag that cannot be read is specified.

In the case of this RFID recorded data, for example, it will be assumed that the total number N of all articles to be shipped from Kanto area to Kansai area at one time and date is seen. An instruction is outputted that Q pieces of the total number N of all articles are respectively loaded on a first palette for shipment, and the data indicating the total number Q loaded on the palette are transmitted to a handy type reader/writer of a physical distribution department from a host computer with a wireless LAN, for example.

Next, it will be assumed that Q pieces of cardboard boxes in which articles are stored are loaded on the palette. When there becomes a state where RFID tags are attached to the respective cardboard boxes one by one, in a physical distribution department, the serial number i from “1” is in turn written into the RFID tags attached to the respective cardboard boxes on each palette one by one by means of the handy type reader/writer, and the end flag (E) is written into the last RFID tag. For example, by drawing a check or the like on each of the cardboard boxes attached to the RFID tag in which writing is completed by means of a magic marker, it is possible to prevent omission of writing of data into the RFID tag. Here, there is particularly no limitation on writing order of data into the RFID tags of each of the cardboard boxes and the like. Serial numbers i may be in turn assigned to the RFID tags of all of the cardboard boxes on the palette from “1”, and the end flag (E) may be written into the last RFID tag.

Next, fifth RFID recorded data will be described. Here, at a side of shipment of articles, it will be assumed that the total number Q of articles to be loaded on an assembly of articles that are subjected to inspection at a time is seen. In this case, data are recorded in an RFID tag attached to the article in accordance with the following rules.

This RFID recorded data are a system for specifying a position in which information for specifying an existence position of the article is further recorded with respect to each of first to fourth RFID recorded data, and are those in which a serial number i and a flag are record in accordance with specific rules so as to be associated with the position of the article to be loaded on the palette (for example, every column, every row or ever cluster) when the serial number is written in the RFID tag at a side of shipment of articles. In the case where there is any RFID tag that cannot be read on inspection at a side of arrival of articles, the loaded position of the article can be estimated from the serial number i and flag falling out.

When the cardboard boxes are loaded on the palette, for example, they are placed in two columns. When the serial numbers are written into the RFID tags by means of a handy type reader/writer, the cardboard boxes in any one of the columns are first subjected to writing, and the cardboard boxes in the other column are subjected to writing later. Then, for example, by drawing a check or the like on each of the cardboard boxes attached to the RFID tag in which writing is completed by means of a magic marker, it is possible to prevent omission of writing of data into the RFID tag.

Here, there is no limitation on writing order of the serial numbers i into the RFID tags in the respective cardboard boxes so long as the RFID tags are located in the same column. Thus, the serial numbers i are in turn assigned. At this time, for example, “01” (“1” in decimal number) which means a first column is additively recorded in the flag in addition to each of the first to fourth RFID recorded data mentioned above by using two bits further in the case where they are to be recorded in the RFID tags of the cardboard boxes loaded on one column. “10” (“2” in decimal number) which means a second column is additively recorded in the case where they are to be recorded in the RFID tags of the cardboard boxes loaded on the other column.

Moreover, in the case where they are divided into n clusters to be loaded on the palette instead of the two columns, the number of bits of the flag in the RFID tag is further added, and a flag (1, 2, 3, . . . , n) is additively recorded in the RFID tag. For example, in the case where the RFID tag having a serial number in the flag 1 cannot be read, the serial number i and the flag on the palette are in turn confirmed by the handy type reader/writer to find the cluster of cardboard boxes loaded as the flag 1, and the inside of the cluster is then confirmed one by one, by which it is possible to specify the cardboard box of the RFID tag that cannot be read.

Next, concrete configuration example of the article management system and the article management method according to the present invention to which the RFID tags having data recording contents as mentioned above will be described using the drawings.

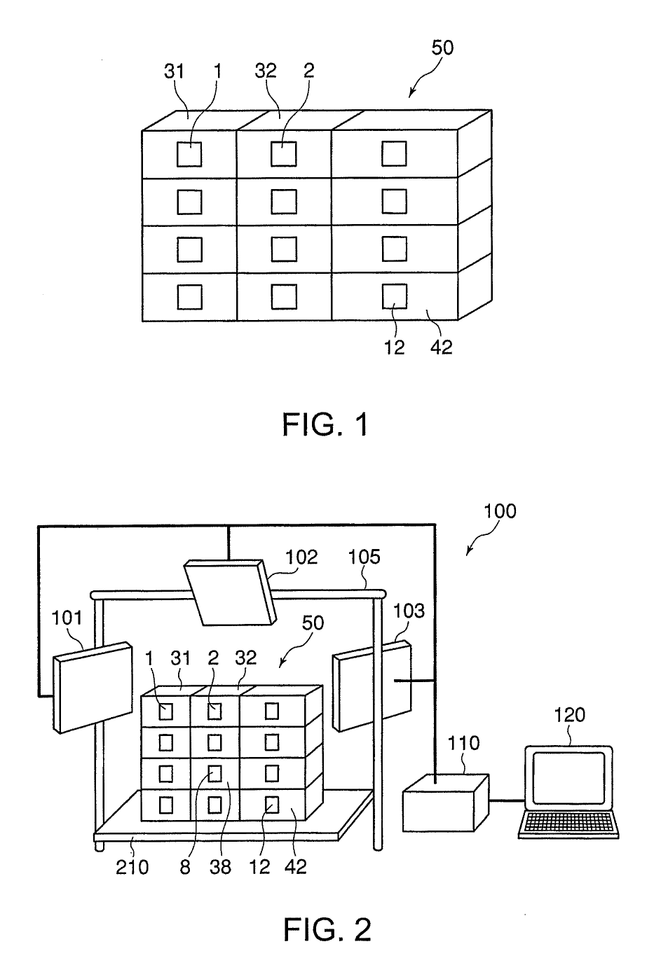

FIG. 1 is a schematic view showing an example of a state of an assembly of articles to be subjected to package inspection in an article management system according to the present invention. As shown in FIG. 1, an assembly 50 of articles is configured from cardboard boxes 31, 32, . . . , 42 stacked as a cluster, in which articles are stored and to which respective RFID tags 1, 2, . . . , 12 are attached. Here, the assembly 50 in which the number of cardboard boxes is 12 pieces (one dozen) as the total number that is a unit of package inspection is illustrated as an example, but the total number is not limited to such a case. There is no limitation on the number of cardboard boxes, and it may be an arbitrary number of pieces.

FIG. 2 is a schematic view showing a gate type inspection apparatus for carrying out package inspection for the assembly 50 of articles at a side of arrival of articles, and shows an example of an apparatus at a side of inspection of articles which constructs the article management system according to the present invention. As shown in a gate type inspection apparatus 100 of FIG. 2, the assembly 50 of articles that is an inspection target is loaded on a palette 210 for ease in movement. The gate type inspection apparatus 100 is constructed so as to include: a gate mechanism composed of three antennas of an antenna 101, an antenna 102 and an antenna 103 each of which emits radio waves toward the RFID tags 1, 2, . . . , 12, that is, a gate system 105; a reader/writer (RFID tag reader/writer) 110 that controls transmitted and received signals of each of the antennas 101, 102, 103; and a display device 120, such as a personal computer, for carrying out an operation of the RFID recorded data transferred from the reader/writer 110 and displaying them.

In this regard, the number of antennas 101, 102, 103 may be one, four or more, or an arbitrary number of pieces between one and plural number so long as recorded data of the RFID tags 1, 2, . . . , 12 in the assembly 50 of articles, which is an inspection target, can thereby be read. Further, mounting places of the antennas 101, 102, 103 on arms of the gate system 105 may also be arbitrary positions on the arms of the gate system 105 so long as they are positions where transmission and reception of radio waves to and from all of the RFID tags 1, 2, . . . , 12 of the cardboard boxes 31, 32, . . . , 42 loaded on the palette 210 are possible. Further, in some cases, they may be slidably attached to the arms of the gate system 105.

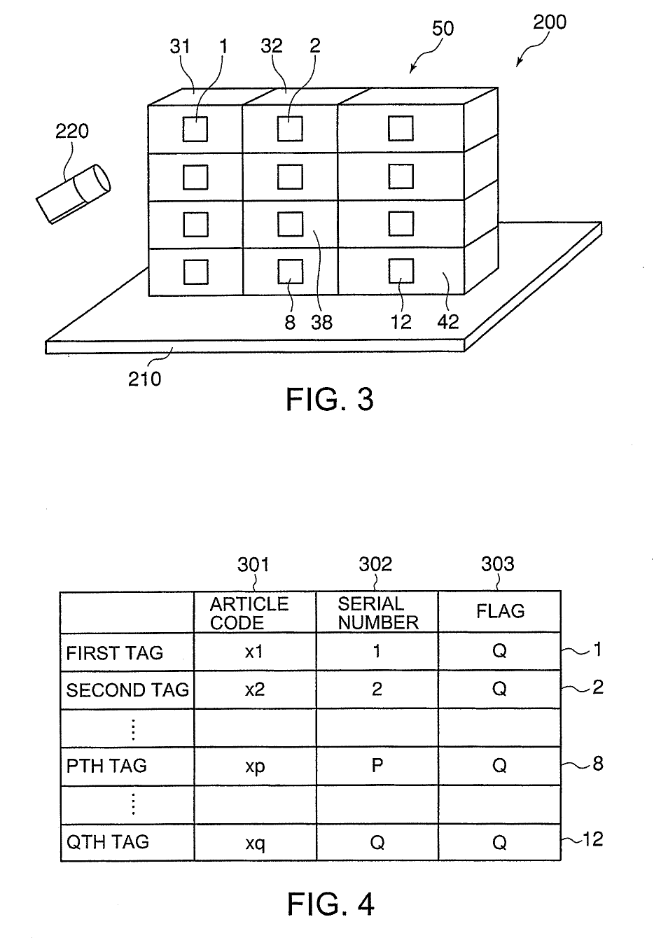

FIG. 3 is a schematic view showing a data writing apparatus for writing data for article management into the assembly 50 of articles at a side of shipment of articles, and shows an example of an apparatus at a side of shipment of articles which constructs the article management system according to the present invention. As shown in the data writing apparatus 200 of FIG. 3, it is constructed so as to include a handy type reader/writer (handy type RFID tag reader/writer) 220 for writing data for article management into RFID tags 1, 2, . . . , 12 respectively attached to the cardboard boxes 31, 32, . . . , 42 of the assembly 50 of articles loaded on the palette 210.

The data for article management are written into the RFID tags 1, 2, . . . , 12 attached to side surfaces of the respective cardboard boxes 31, 32, . . . , 42 by the handy type reader/writer 220 with loaded on the palette 210 for ease in movement. In this regard, the data for article management may be written at an arbitrary place by the handy type reader/writer 220 even without loaded on the palette 50 so long as the assembly 50 of articles that becomes a target for package inspection can be specified.

Next, an example of an operation of the gate type inspection apparatus 100 at the side of arrival of articles shown in FIG. 2 will be described. As described above, with loaded on the palette 210, the assembly 50 of articles is causes to pass through the inside of the gate system 105 by means of a carriage or a fork lift. At this time, a reading instruction to read the data of the RFID tags 1, 2, . . . , 12 attached to the respective cardboard boxes 31, 32, . . . , 42 is transmitted toward the assembly 50 of articles from the three antennas 101, 102, 103 through the radio waves.

When the respective RFID tags 1, 2, . . . , 12 attached to the cardboard boxes 31, 32, . . . , 42 receive radio waves with a level of radio field intensity more than a threshold value, they decode the instruction of the radio wave. In the case where it is the reading instruction, data stored in respective memories in the RFID tags 1, 2, . . . , 12 is read. The radio wave including the read data is transmitted toward the antennas 101, 102, 103 from the RFID tags 1, 2, . . . , 12.

When at least one of the three antennas 101, 102, 103 receives the radio wave from any of the RFID tags 1, 2, . . . , 12, the received data are transferred to the display device 120 such as a personal computer via the reader/writer 110, and the data are displayed on the display device 120.

Next, an example of an operation of the data writing apparatus 200 at the side of shipment of articles shown in FIG. 3 will be described. In the data writing apparatus 200, the RFID tags 1, 2, . . . , 12 are attached to the respective side surfaces of the cardboard boxes 31, 32, . . . , 42 constituting the assembly 50 of articles that become a target of package management for the articles. Therefore, as described above, using the handy type reader/writer 220, respective data for article management are written into the RFID tags 1, 2, . . . , 12 as RFID recorded data in the order selected arbitrarily. For example, starting from the RFID tag 1 attached to the cardboard box 31 to the RFID tag 12 attached to the last cardboard box 42, the data for article management including the serial number i and the flag are in turn written into the respective RFID tags 1, 2, . . . , 12 by the handy type reader/writer 220.

(First Example of Recording Data for Management of Articles)

FIG. 4 is a table for explaining an example of data to be written for article management into the RFID tags 1, 2, . . . , 12 respectively attached to the cardboard boxes 31, 32, . . . , 42 in the data writing apparatus 200 at a side of shipment of articles, and shows an example of the first RFID recorded data described above.

In FIG. 4, an article code 301 is a special code linking to each of the articles for specifying the article. A serial number 302 is a consecutive number starting from “1” that is applied to each of the RFID tags 1, 2, . . . , 12 attached to the respective cardboard boxes 31, 32, . . . , 42 of the assembly 50 of articles that is a package management target at a side of shipment. Further, a flag 303 records Q (12 in the present embodiment) indicating the total number of cardboard boxes 31, 32, . . . , 42 of the assembly 50 of articles that becomes a package management target to all of the RFID tags 1, 2, . . . , 12.

For example, as shown in FIG. 4, the data to be recorded for article management into the first RFID tag 1 attached to the first cardboard box 31 have X1 as the article code, one as the serial number and Q as the flag. Further, the data to be recorded for article management into the second RFID tag 2 attached to the second cardboard box 32 have X2 as the article code, two as the serial number and Q as the flag. Further, the data to be recorded for article management into the Pth RFID tag 8 attached to the Pth cardboard box 38 have Xp as the article code, P as the serial number and Q as the flag. The data to be recorded for article management into the Qth RFID tag 12 attached to the last Qth cardboard box 42 have Xq as the article code, Q as the serial number and Q as the flag.

Such data are prepared, and the data for article management are in turn written into all of the RFID tags 1, 2, . . . , 12 attached to the respective cardboard boxes 31, 32, . . . , 42 loaded on the palette 210 using the handy type reader/writer 220.

The assembly 50 of articles of the cardboard boxes 31, 32, . . . , 42 attached to the respective RFID tags 1, 2, . . . , 12 in which the data for article management are recorded as FIG. 4 is brought in a side of arrival of articles. In the case where all of the data of the RFID tags 1, 2, . . . , 12 are correctly read when the data of the RFID tags 1, 2, . . . , 12 are read in the gate type inspection apparatus 100 of FIG. 2, the same data as those in FIG. 4 should be acquired.

In the case where there is any RFID tag that cannot be read, it is possible to specify what number RFID tag cannot be read and how many RFID tags cannot be read from the total number Q of arrivals and the serial numbers i. For example, in the case where only the Pth RFID tag 8 cannot be read, it can be seen that only the Pth RFID tag 8 could not be read because only the RFID tag of the serial number (P) fell out from the serial numbers of the read RFID tags.

Even in the case where the last RFID tag 12 cannot be read, it is possible to specify the total number Q and the serial number of the RFID tag 12 that could not be read from the flags and the serial numbers recorded in the other RFID tags that could be read.

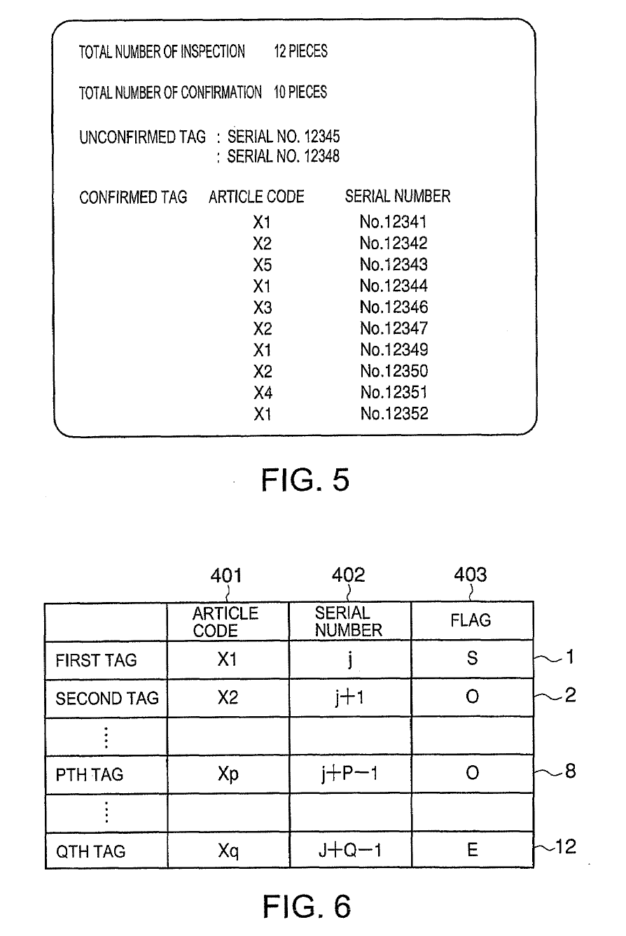

FIG. 5 shows an example displayed as an inspection result of articles on the display device 120 at the side of arrival of articles in FIG. 2. In FIG. 5, the case where the total inspection number Q of the assembly 50 of articles caused to pass through the gate system 105 of the gate type inspection apparatus 100 at the side of arrival of articles is twelve pieces of serial numbers from “12341” to “12352”, the total confirmation number of RFID tags in which reading of data recorded in the RFID tag can be confirmed is ten pieces of them and the serial numbers of the RFID tags in which reading cannot be confirmed are two pieces, “12345” and “12348”, is shown.

Thus, even in the case where the total inspection number Q of the assembly 50 of articles caused to pass through the gate system 105 of the gate type inspection apparatus 100 at the side of arrival of articles is not seen in advance, or, even in the case where any RFID tag that could not be read exists, by utilizing the other RFID tags that could be read, it can be displayed on the display device 120 which the total inspection number is twelve pieces, two RFID tags that could not be read exist, and the serial numbers thereof are two pieces, “12345” and “12348”.

Therefore, in the case of subjecting the assembly 50 of articles to package inspection, it is possible to grasp the total number Q at the side of arrival of articles without acquiring a shipment slip or the like from the side of shipment of articles even when the total number Q included in the assembly 50 of articles is unknown. The reason is that the total number Q of articles of the inspection targets is recorded in all of the read RFID tags. Further, in the case of carrying out package inspection, it is possible to specify the number of RFID tags that could not be read and the serial numbers thereof without a shipment slip or the like. The reason is that missing numbers that could not be read can be specified by referring to the serial numbers of the RFID tags that could be read because a series of consecutive numbers are applied thereto as the serial numbers of the respective RFID tags.

(Second Example of Recording Data for Management of Articles)

Next, an example in which data with different contents from those in FIG. 4 described above are recorded in the respective RFID tags as data for article management will be described as a second example of recording data for management of articles.

FIG. 6 shows a table for explaining another example of data to be written for article management into the RFID tags 1, 2, . . . , 12 respectively attached to the cardboard boxes 31, 32, . . . , 42 in the data writing apparatus 200 at a side of shipment of articles, and shows an example of the second RFID recorded data described above.

In FIG. 6, an article code 401 is a special code linking to each of the articles for specifying the article in the similar manner to the case of FIG. 4. A serial number 402 is a sequence number applied arbitrarily at the side of shipment, but is a consecutive number in the assembly 50 of articles that become package inspection targets. In the example of FIG. 6, the total number that is a package inspection target is Q pieces, and the serial numbers are a series of consecutive numbers starting from “j” and continuing to “j+Q−1”. Further, in a flag 403, a start flag (S) is recorded in the RFID tag 1 attached to the first cardboard box 31 of the cardboard boxes 31, 32, . . . , 42 of the assembly 50 of articles that become package management targets, and an end flag (E) is record in the RFID tag 12 attached to the last cardboard box 42.

For example, as shown in FIG. 6, the data to be recorded for article management into the first RFID tag 1 attached to the first cardboard box 31 have X1 as the article code, j as the serial number and S as the flag indicating the first. Further, the data to be recorded for article management into the second RFID tag 2 attached to the second cardboard box 32 have X2 as the article code, (j+1) as the serial number and 0 as the flag. Further, the data to be recorded for article management into the Pth RFID tag 8 attached to the Pth cardboard box 38 have Xp as the article code, a (j+P−1) as the serial number and 0 as the flag. The data to be recorded for article management into the Qth RFID tag 12 attached to the last Qth cardboard box 42 have Xq as the article code, (j+Q−1) as the serial number and E as the flag indicating the last.

Such data are prepared, and the data for article management are in turn written into all of the RFID tags 1, 2, . . . , 12 attached to the respective cardboard boxes 31, 32, . . . , 42 loaded on the palette 210 using the handy type reader/writer 220.

The assembly 50 of articles of the cardboard boxes 31, 32, . . . , 42 attached to the respective RFID tags 1, 2, . . . , 12 in which the data for article management are recorded as FIG. 6 is brought in a side of arrival of articles. In the case where all of the data of the RFID tags 1, 2, . . . , 12 can be correctly read when the data of the RFID tags 1, 2, . . . , 12 are read in the gate type inspection apparatus 100 of FIG. 2, it can be seen that the total inspection number is Q pieces by subtracting the serial number (j) of the RFID tag 1 to which the start flag (S) is applied from the serial number (j+Q−1) of the RFID tag 12 to which the end flag (E) is applied and then adding “1” thereto.

In the case where there is any RFID tag that cannot be read, it is possible to specify what number RFID tag cannot be read and how many RFID tags cannot be read from the total number Q of arrivals and the serial numbers i in the similar manner to the case in FIG. 4. For example, in the case where only the Pth RFID tag 8 cannot be read, it can be seen that the Pth RFID tag 8 obtained by subtracting the serial number (i) of the first RFID tag 1 therefrom and then adding “1” thereto could not be read because only the RFID tag of the serial number (j+P−1) fell out therefrom.

In the case where the first RFID tag 1 or the last RFID tag 12 cannot be read, it can be seen that the first RFID tag 1 or the last RFID tag 12 could not be read because the RFID tag to which the start flag (S) is applied or the RFID tag to which the end flag (E) is applied does not exist in the read RFID tags that have been read. In such a case, by transmitting a package reading instruction from the antennas 101, 102, 103 again or by reading and confirming the RFID tags one by one using the handy type reader/writer, the RFID tag that could not be read is to be specified.

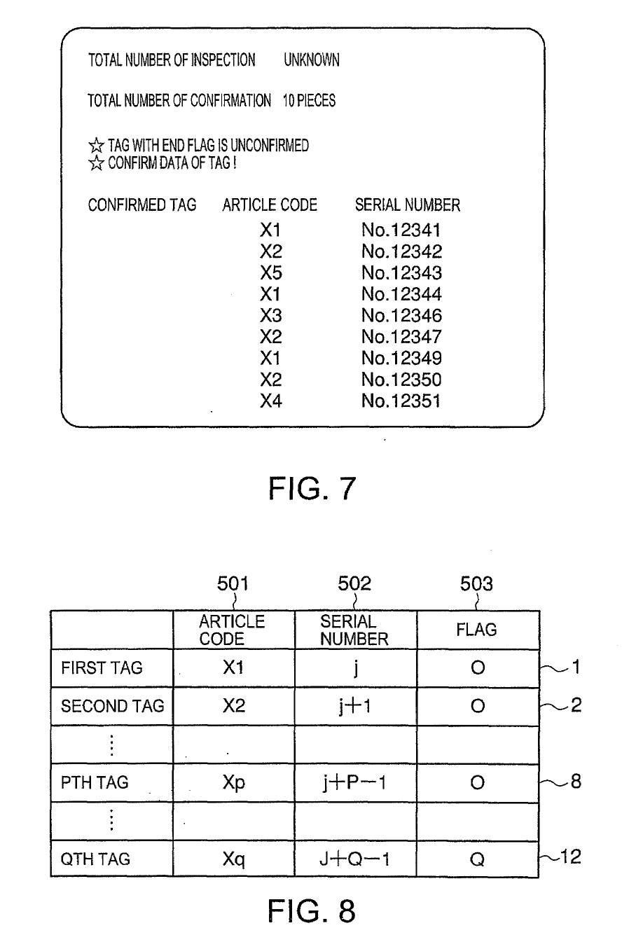

FIG. 7 is a screen display view showing a screen display example in the case where the last RFID tag 12 in which the end flag (E) is recorded could not be read, and is a screen display view in which reconfirmation of the assembly 50 of articles of the package inspection target is requested. As shown in FIG. 7, it is shown that the assembly 50 of articles caused to pass through the gate system 105 of the gate type inspection apparatus 100 at the side of arrival of articles is a cluster of articles in which the serial number of the RFID tag 1 to which a start flag (S) is applied starts from “12341”, and the last RFID tag to which an end flag (E) is applied could not be read although ten pieces of RFID tags can be confirmed. For this reason, the case where the total inspection number Q is “unknown”, and a warning message of “confirm data of tag!” for requesting reconfirmation of the data of the RFID tag is displayed because “the tag with the end flag is unconfirmed” is further shown.

(Third Example of Recording Data for Management of Articles)

Next, an example in which data with further different contents from those in FIG. 4 described above are recorded in the respective RFID tags as data for article management will be described as a third example of recording data for management of articles.

FIG. 8 is a table for explaining still another example of the data for article management which are written into the RFID tags 1, 2, . . . , 12 respectively attached to the cardboard boxes 31, 32, . . . , 42 in the data writing apparatus 200 at the side of shipment of articles, and shows an example of the third RFID recorded data described above.

In FIG. 8, an article code 501 is a special code linking to each of the articles for specifying the article in the similar manner to the case of FIG. 4. A serial number 502 is, in the similar manner to the case of FIG. 6, a sequence number applied arbitrarily at the side of shipment, but is a consecutive number in the assembly 50 of articles that become package inspection targets. In the example of FIG. 8, the total number that is a package inspection target is Q pieces, and the serial numbers are a series of consecutive numbers starting from “j” and continuing to “j+Q−1”. Further, in a flag 503, the total number (Q) of articles that become package inspection targets is recorded in the RFID tag 12 attached to the last cardboard box 42 of the cardboard boxes 31, 32, . . . , 42 of the assembly 50 of articles that become package management targets.

For example, as shown in FIG. 8, the data to be recorded for article management into the first RFID tag 1 attached to the first cardboard box 31 have X1 as the article code, j as the serial number and 0 as the flag. Further, the data to be recorded for article management into the second RFID tag 2 attached to the second cardboard box 32 have X2 as the article code, (j+1) as the serial number and 0 as the flag. Further, the data to be recorded for article management into the Pth RFID tag 8 attached to the Pth cardboard box 38 have Xp as the article code, (j+P−1) as the serial number and 0 as the flag. The data to be recorded for article management into the Qth RFID tag 12 attached to the last Qth cardboard box 42 have Xq as the article code, (j+Q−1) as the serial number and Q as the flag indicating the total number.

Such data are prepared, and the data for article management are in turn written into all of the RFID tags 1, 2, . . . , 12 attached to the respective cardboard boxes 31, 32, . . . , 42 loaded on the palette 210 using the handy type reader/writer 220.

The assembly 50 of articles of the cardboard boxes 31, 32, . . . , 42 attached to the respective RFID tags 1, 2, . . . , 12 in which the data for article management are recorded as FIG. 8 is brought in a side of arrival of articles. In the case where all of the data of the RFID tags 1, 2, . . . , 12 can be correctly read when the data of the RFID tags 1, 2, . . . , 12 are read in the gate type inspection apparatus 100 of FIG. 2, it can be seen that the total inspection number is Q pieces from the total number recorded in the flag of the last RFID tag 12, and it can also be seen that the RFID tag 12 in which this total number Q is recorded is the last RFID tag. Further, inasmuch as the serial number (j+Q−1) of the last RFID tag 12 and a numeral value of the total number Q are seen, a serial number j of the first RFID tag can also be seen.

In the case where there is any RFID tag that cannot be read when the total number Q of the inspection target is seen, it is possible to specify what number RFID tag cannot be read and how many RFID tags cannot be read from the total number Q of arrivals and the serial number i in the similar manner to the case of FIG. 4. For example, in the case where only the Pth RFID tag 8 cannot be read, it can be seen that only the Pth RFID tag 8 could not be read by subtracting the serial number (j) of the first RFID tag 1 therefrom and then adding “1” thereto because only the RFID tag of the serial number (j+P−1) fell out therefrom.

In the case where the last Qth RFID tag 12 cannot be read, it can be seen that the last RFID tag 12 could not be read because the RFID tag in which the total number (Q) is applied to the flag does not exist in the RFID tags that have been read. In such a case, by transmitting a package reading instruction from the antennas 101, 102, 103 again or by reading and confirming the RFID tags one by one using the handy type reader/writer, the RFID tag that could not be read is to be specified.

(Fourth Example of Recording Data for Management of Articles)

Next, an example in which data with further different contents from those in FIG. 4 described above are recorded in the respective RFID tags as data for article management will be described as a fourth example of recording data for management of articles.

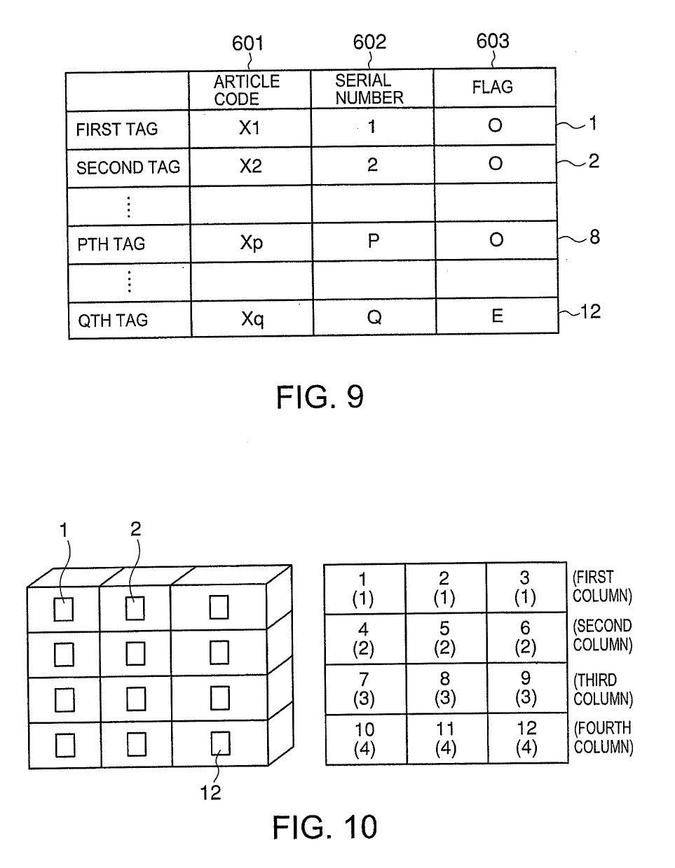

FIG. 9 shows a table for explaining still another example of the data for article management which are written into the RFID tags 1, 2, . . . , 12 respectively attached to the cardboard boxes 31, 32, . . . , 42 in the data writing apparatus 200 at the side of shipment of articles, and shows an example of the fourth RFID recorded data described above.

In FIG. 9, an article code 601 is a special code linking to each of the articles for specifying the article in the similar manner to the case of FIG. 4. A serial number 602 is, in the similar manner to the case of FIG. 4, a sequence number starting from “1” applied to the RFID tags 1, 2, . . . , 12 attached to the respective cardboard boxes 31, 32, . . . , 42 of the assembly 50 of articles that become the package management targets at the side of shipment. In a flag 603, an end flag (E) is recorded in the RFID tag 12 attached to the last cardboard box 42 of the cardboard boxes 31, 32, . . . , 42 of the assembly 50 of articles that become package management targets.

For example, as shown in FIG. 9, the data to be recorded for article management into the first RFID tag 1 attached to the first cardboard box 31 have X1 as the article code, one as the serial number and 0 as the flag. Further, the data to be recorded for article management into the second RFID tag 2 attached to the second cardboard box 32 have X2 as the article code, two as the serial number and 0 as the flag. Further, the data to be recorded for article management into the Pth RFID tag 8 attached to the Pth cardboard box 38 have Xp as the article code, P as the serial number and 0 as the flag. The data to be recorded for article management into the Qth RFID tag 12 attached to the last Qth cardboard box 42 have Xq as the article code, Q as the serial number and E as the flag indicating the last.

Such data are prepared, and the data for article management are in turn written into all of the RFID tags 1, 2, . . . , 12 attached to the respective cardboard boxes 31, 32, . . . , 42 loaded on the palette 210 using the handy type reader/writer 220.

The assembly 50 of articles of the cardboard boxes 31, 32, . . . , 42 attached to the respective RFID tags 1, 2, . . . , 12 in which the data for article management are recorded as FIG. 9 is brought in a side of arrival of articles. In the case where all of the data of the RFID tags 1, 2, . . . , 12 can be correctly read when the data of the RFID tags 1, 2, . . . , 12 are read in the gate type inspection apparatus 100 of FIG. 2, it can be seen that the total inspection number is Q pieces because it can be seen that the last serial number is Q from the end flag (E) recorded in the flag of the last RFID tag 12. Further, a serial number of the first RFID tag is recorded as “1”.

In the case where there is any RFID tag that cannot be read when the total number Q of the inspection target is seen, it is possible to specify what number RFID tag cannot be read and how many RFID tags cannot be read from the total number Q of arrivals and the serial number i in the similar manner to the case of FIG. 4. For example, in the case where only the Pth RFID tag 8 cannot be read, it can be seen that only the Pth RFID tag 8 could not be read because only the RFID tag of the serial number (P) fell out therefrom.

In the case where the last Qth RFID tag 12 cannot be read, it can be seen that the last RFID tag 12 could not be read because the RFID tag in which the end flag (E) indicating the last is applied to the flag does not exist in the RFID tags that have been read. In such a case, by transmitting a package reading instruction from the antennas 101, 102, 103 again or by reading and confirming the RFID tags one by one using the handy type reader/writer, the RFID tag that could not be read is to be specified.

(Fifth Example of Recording Data for Management of Articles)

Next, an example in which data with further different contents from those in FIGS. 4 to 9 described above are recorded in the respective RFID tags as data for article management will be described as a fifth example of recording data for management of articles.

FIG. 10 is an explanatory view for explaining a different method of applying serial numbers which are written for article management into the RFID tags 1, 2, . . . , 12 respectively attached to the cardboard boxes 31, 32, . . . , 42 in the data writing apparatus 200 at the side of shipment of articles, and shows an example of the fifth RFID recorded data described above. More specifically, FIG. 10 shows an example of a position specifying system for recording serial numbers i, in accordance with specific rules, so as to be associated with loaded positions of the cardboard boxes 31, 32, . . . , 42, in which articles are stored, loaded on the palette 210 (for example, row number, column number, cluster number or the like). In the present embodiment, an example in which serial numbers are in turn applied in accordance with loaded columns and codes indicating their column positions are applied to the flags.

Here, “1” to “4” are respectively recorded as the flags in response to a first column to fourth column, and as an example of continuously recording serial numbers for every column, “1” to “3”, “4” to “6”, “7” to “9” and “10” to “12” are in turn recorded by applying consecutive numbers in the respective columns from the first column to the fourth column and applying a number consecutive from a last serial number of a previous column to a first serial number of a next column.

As FIG. 10, by recording a flag and a serial number in each of the RFID tags 1, 2, . . . , 12 for each column in turn, in the case where any RFID tag that could not be read exists when package inspection is carried out at a side of arrival of articles, it is possible to immediately specify which position the cardboard box is loaded on the palette 210 because the flag and the serial number correspond to a position of the cardboard box in which the corresponding articles are stored.

As explained above in detail, on article management in shipment, acceptance, transportation, inventory and the like of articles, in order to effectively achieve a mechanism to collectively manage a plurality of articles, not individual article, flags capable of calculating at least consecutive and separate serial numbers for respective articles and the total number of articles of management targets are applied as data for article management, that is, information capable of grasping the total number of articles that are targets of package management is written in the RFID tags as systematic codes, by which the total number can be grasped even though the total number of articles of targets is not separately sent like a delivery slip or the like. In addition, even though it fails to read an RFID tag, it is possible to readily grasp how many RFID tags it fails to read, furthermore, which RFID tag of an article cannot be read.

In this regard, in the embodiment described above, an example in which the handy type reader/writer 220 is used as a device for writing data for article management into the RFID tags at the data writing apparatus 200 shown in FIG. 3 has been described. However, the present invention is not limited to only such a case.

For example, for writing the respective data into the RFID tags 1, 2, . . . , 12 attached to the cardboard boxes 31, 32, . . . , 42 when the palette 210 on which the cardboard boxes 31, 32, . . . , 42, in each of which the articles of management targets are stored, are loaded is caused to pass through the gate system, antennas slidable up and down may be respectively disposed on the arms at both sides of the gate mechanism (gate system) through which the cardboard boxes 31, 32, . . . , 42 are caused to pass, and an RFID tag reader/writer for controlling radio waves to be transmitted and received via the antennas may be provided.

Here, it is preferable that the radio waves controlled by this RFID tag reader/writer are those in which an arrival distance of the radio waves is shorter so that data can be surely written into only the corresponding RFID tag attached to the cardboard box.

Moreover, the antenna for transmitting and receiving radio waves by control of the RFID tag reader/writer may be one slidable on the arm not only up and down but also right and left. For example, an openable and closable arm may be provided as the gate system. The antenna for transmitting and receiving the radio waves may be able to slide right and left to an arbitrary position on the arm in the case where the gate is made to be a closed state by making the arm level.

Next, another embodiment of the present invention will be described with reference to the drawings.

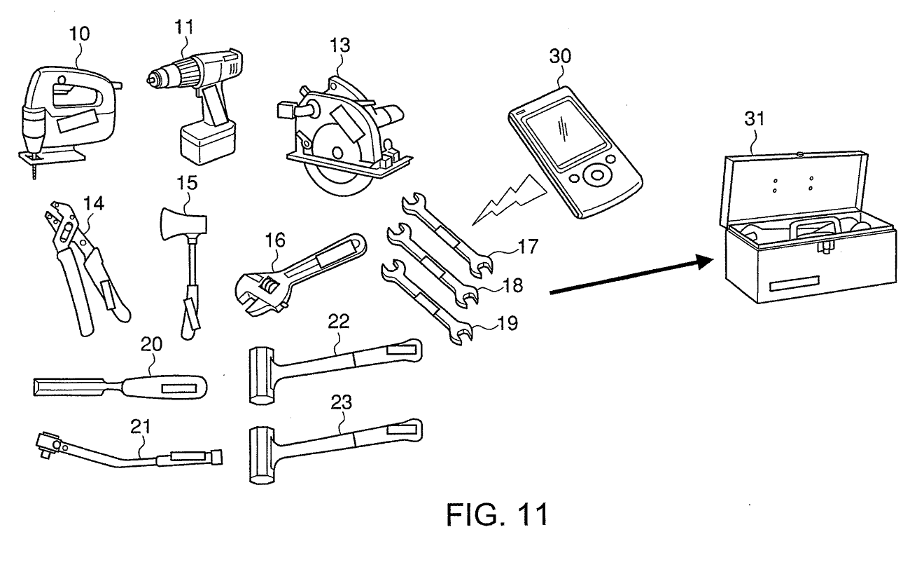

FIG. 11 is a view showing a writing system on lending of equipment such as tools and medical devices. RFID tags are attached to items 10 to 23 of respective lending targets one by one. By placing the RFID tags attached to the items 10 to 23 of the lending targets over a handy type reader/writer 30 at lending, serial numbers are written thereinto in a lending order.

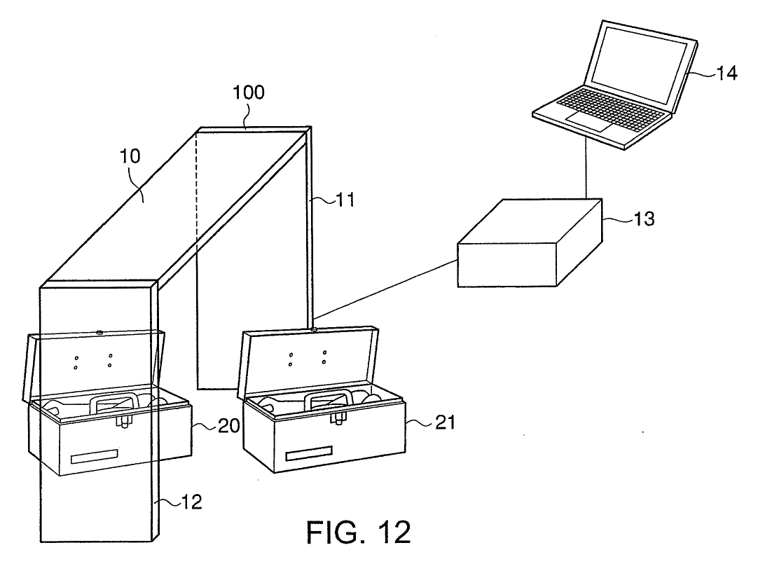

FIG. 12 shows an example of a system configuration for confirmation of a mislaid item at a work site when items are to be returned. A gate type inspection system is constructed from: a gate system 100 composed of three antennas of an antenna 10, an antenna 11 and an antenna 12, which emit radiation at radio wavelengths toward an RFID tag; a reader/writer 13 that controls transmitted signals from the antennas; and a personal computer 14 that carries out an operation for data transmitted from the reader/writer and displays them. The number of antennas may be either one or four or more.

Processes at lending of the items in FIG. 11 will first be described. The RFID tags are attached to the items 10 to 23 of the respective lending targets one by one, and by placing the RFID tags attached to the items 10 to 23 of the lending targets over the handy type reader/writer 30 at lending, the serial numbers are written thereinto in the lending order. A serial number 1 and a flag 0 are written into the item 10 that is first placed thereover, and a serial number 2 and the flag 0 are written into the second lending item 11. Subsequently, the items 10 to 23 of the lending targets are in turn placed over the handy type reader/writer 30, a serial number N corresponding to a lending order N and the flag 0 are written. When writing to a last lending item is completed, a number by adding one to a last lending item number and a flag E indicating the last are written into the RFID tag attached to the item storage case 30.

Thus, by causing a storage case in which the items with tags into each of which the serial number and the flag are described are stored at return to pass through the gate system of a configuration as shown in FIG. 12, it is possible to quickly confirm whether all of the lending items get together without mislaid.

Next, still another embodiment of the present invention will be described with reference to the drawings.

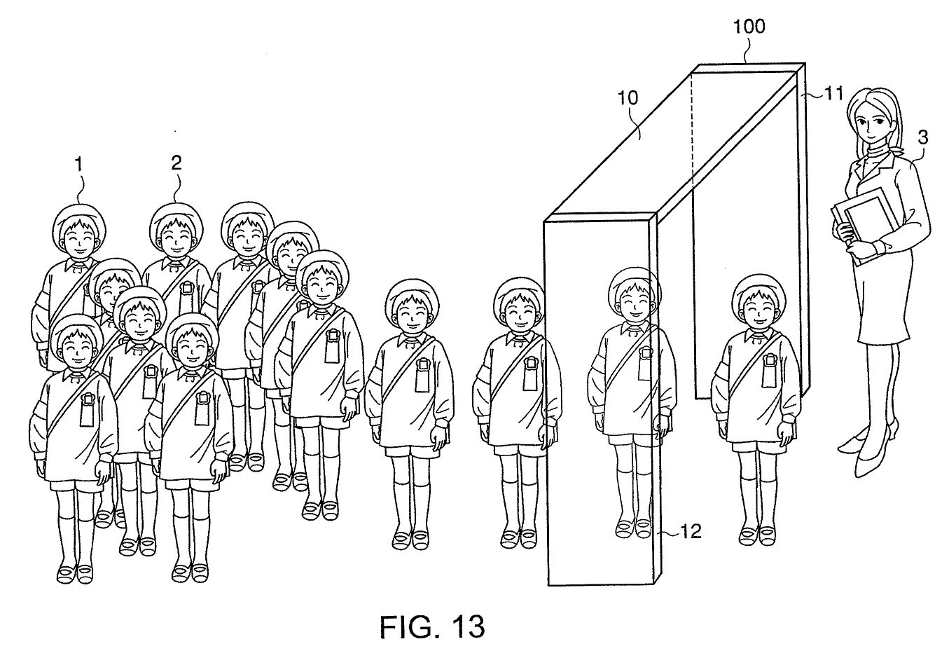

FIG. 13 shows an applicable example to an entering and leaving, and a roll call management system with respect to a group of a child educational institution such as a kindergarten and a nursery school, a nursing home or the like. A group manager 3 attaches RFID tags to management subjects at a leaving time from an institution by inserting them into nameplates or the like, and causes the management subject to pass through the gate system 100. The gate system 100 writes serial numbers of pass-through order and a flag value 0 into the RFID tags of the management subjects in pass-through order. The group manager finally passes through the gate system while wearing the RFID tag into which a flag E is written, and a value of the serial number of the management subjects +1 is written thereinto.

When they return to the institution, the group manager 3 first passes through the gate system 100. At that time, the flag E and the total number are read by the gate system. Hereinafter, the management subjects pass through the gate in turn, by which a quick roll call and confirmation are completed. Further, the group manager carries the handy type reader/writer, by which the similar function can be achieved at an outside location.

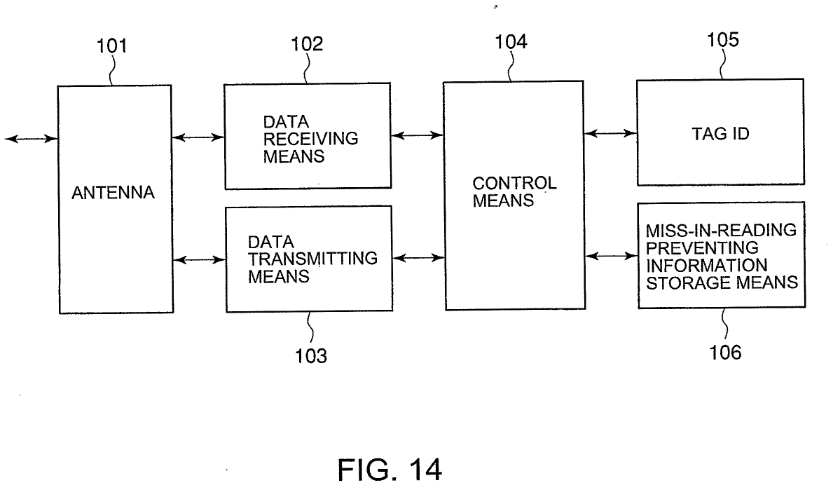

Hereinafter, still another embodiment of the system and method described above will be described with reference to FIGS. 14 to 17.

The RFID tag used in the present invention is provided with a miss-in-reading preventing information storage means 106 for storing information designed to prevent a miss in reading in addition to its own ID.

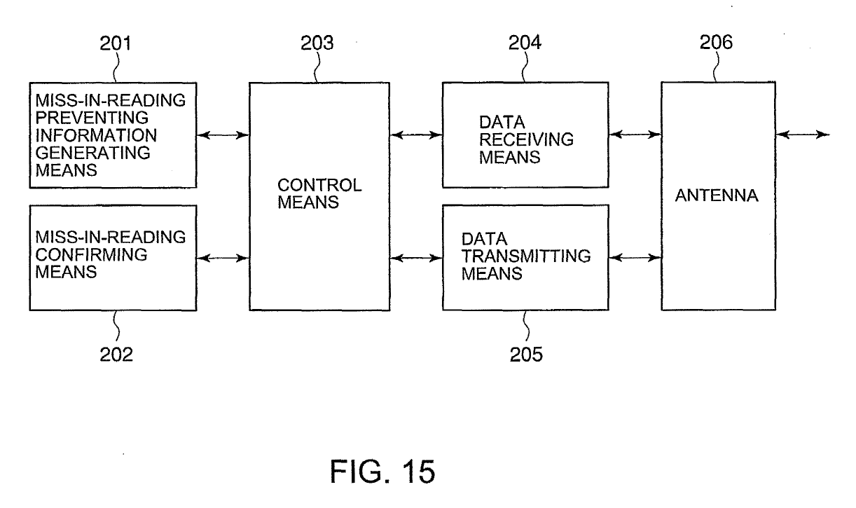

An operating device for RFID used in the present invention is provided with control means 203 for temporarily storing IDs of all tags detected as shown in FIG. 15 and for storing miss-in-reading preventing information created on the basis of its ID information in the miss-in-reading preventing information storage means 106 of the RFID tags used in the present invention.

The operating device for RFID used in the present invention detects which lot of an RFID tag a miss in reading occurs with respect to the RFID tags attached to articles in a plurality of lot from the ID of the tag detected at reading of the tags and the miss-in-reading preventing information stored in the above-mentioned miss-in-reading preventing information storage means 104.

In a method of the present invention, the miss-in-reading preventing information storage means is caused to store the miss-in-reading preventing information on the RFID tags in a lot unit at shipment. This miss-in-reading preventing information is hash data created with hash algorithm on the basis of the IDs of all RFID tags belonging to the same lot. By causing the tag to store the hash data based on the IDs of all RFID tags belonging to the same lot as the miss-in-reading preventing information, it not only functions as an identifier for every lot, determination of a miss in reading is but also possible by taking a step of creating the hash data on the basis of the IDs of the tags whose miss-in-reading preventing information is the same at inspection, and a step of comparing them.

Hereinafter, a concrete configuration of the operating devices for the RFID tags will be described. FIG. 14 is a block diagram showing a schematic configuration of the embodiment of the RFID tag according to the present invention, and FIG. 15 is a block diagram showing a schematic configuration of the embodiment of the operating device for the RFID tags according to the present invention. As shown in FIG. 14, the RFID tag used in the present invention includes: an antenna 101 for carrying out transmission and reception of radio waves to and from the RFID tag operating apparatus; data receiving means 102 for decoding the received radio waves; data transmitting means 103 for encoding data to be transmitted to transmitted radio waves; control means 104 for processing the signals from the operating device in the RFID tag; an ID 105 of the RFID tag; and miss-in-reading preventing information storage means 106.

As shown in FIG. 15, the operating apparatus for the RFID tags according to the present invention includes: an antenna 206 for carrying out transmission and reception of radio waves to and from the RFID tag; data receiving means 204 for decoding the received radio waves; data transmitting means 205 for encoding data to be transmitted to transmitted radio waves; the control means 203 for controlling the operating device to write and read against the RFID tag, and to produce an ID acquisition signal; miss-in-reading preventing information generating means 201 for generating data to be stored in the miss-in-reading preventing information storage means of the RFID tag; and miss-in-reading confirming means 202 for determining whether or not there is a miss in reading of an RFID tag in the same lot on the basis of the IDs of the RFID tag and the miss-in-reading preventing information.

Hereinafter, the operation of the present embodiment will be described. The method according to the present invention basically consists of a step of generating miss-in-reading preventing information in the miss-in-reading preventing information generating means 201 of the RFID tag operating apparatus at shipment and of storing it in the miss-in-reading preventing information storage means 106 of the RFID tag attached to the article; and a step of determining whether or not there is a miss in reading of an RFID tag attached to the articles in the same lot in the miss-in-reading confirming means 202 of the operating apparatus for the RFID tags at inspection.

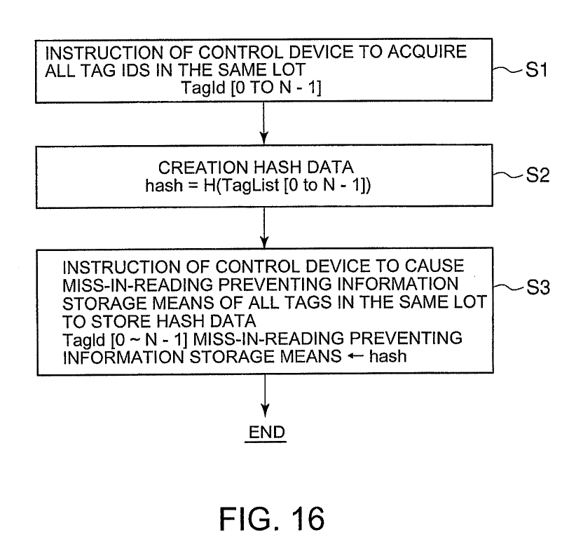

FIG. 16 is a flowchart showing process steps from generation of the miss-in-reading preventing information to storage in the RFID tag attached to the article, which are carried out by the miss-in-reading preventing information generating means 201 of the operating apparatus for RFID tags at shipment.

A first process step is first to cause a control device to carry out an instruction to acquire an ID list for all tags that belong to the same lot (Step S1). In the method of the present invention, the RFID tags attached to the articles are to be read for every lot in reading at shipment, and it will be assumed that there is no miss in reading at this time.

A second process step is to create hash data, which are a digest of all tags, using a hash algorithm on the basis of all IDs of the acquired tags (Step S2). In the method of the present invention, a kind of hash algorithm is not particularly limited. It may accomplish a function of the check sum.

As a third process step, the control device 203 causes the miss-in-reading preventing information storage means 106 to carry out a processing instruction to store the created hash data on all of the tags that belong to the same lot (Step S3).

By carrying out the processes of the Steps S1 to S3 for each lot, it is possible to store different hash data in every lot. This hash data not only function as an identifier of the lot, but also is used to determine whether or not a miss in reading occurs at inspection.

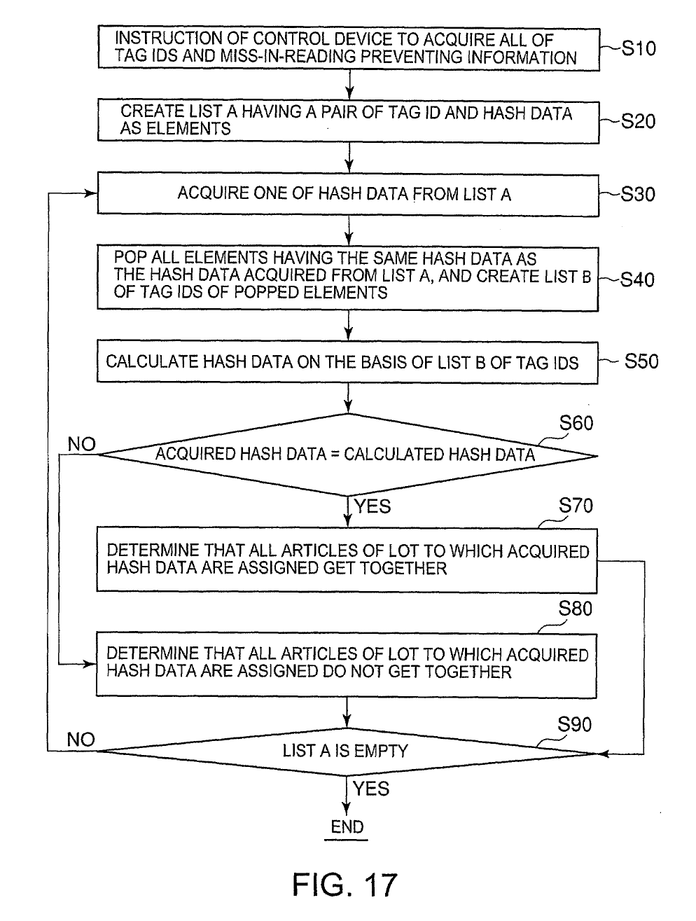

FIG. 17 is a flowchart for explaining process steps of determining whether or not there is a miss in reading of the RFID tags attached to the articles in the same lot, which are carried out by the miss-in-reading confirming means 202 of the operating apparatus for the RFID tags at inspection.

As a first process step, the control means 203 is caused to carry out an instruction to acquire all of the tag IDs and the hash data stored in the miss-in-reading preventing information storage means 106 (Step S10).

As a second process step, a list A having a pair of the acquired respective tag ID and hash data as elements is created (Step S20).

As a third process step, one of hash data H that becomes an identifier of a lot to be inspected is acquired from the list A (Step S30).

As a fourth process step, all elements having the same hash data as the hash data acquired from the list A are popped, and a list B in which IDs are extracted from all of the popped elements is created (Step S40).

As a fifth process step, hash data that become a digest of all of the tags included in the list B are created using hash algorithm on the basis of all IDs included in the list B (Step S50).

As a sixth process step, the hash data created from the created list B are compared with hash data H of a lot to be subjected to inspection (Step S60).

In the case where the hash data are identical to each other, it proceeds to S70. In the case where the hash data are different from each other, it proceeds to S80.

At S70, in the case where the hash data are identical to each other, it is determined that all of the RFID tags attached to the articles of the lot subjected to the inspection get together, and it proceeds to S90.

At S80, in the case where the hash data are different from each other, it is determined that all of the RFID tags attached to the articles of the lot subjected to the inspection do not get together, and it proceeds to S90.

At Step S90, in the case where the list A is empty, it is terminated because the process has been carried out for all of the lots. In the case where the list A is not empty, it returns to Step S30 because there is a lot that has not been subjected to inspection yet.

According to the present embodiment, on inspection work for which a plurality of lots exist, it is possible to know which lot an RFID tag attached to an article fell out.

In this regard, significant information such as the IDs of the tags in the same lot can be stored as the miss-in-reading preventing information. However, in the case where the significant information is stored, important data are stolen by a skimmer when they are skimmed. However, as the embodiments of the present invention, by utilizing the hash data as the miss-in-reading preventing information, significant data would not have to be stolen by a skimmer when skimming is carried out.

As described above, the configuration of the preferred embodiments of the present invention has been explained. However, it should be noted that such embodiments are nothing more than mere illustrations of the present invention and they are not limited in the present invention. It can readily be understood for those skilled in the art that various modifications and changes can be made in accordance with particular application without departing from the scope of the present invention.

1-58. (canceled)

59. An electronic tag attached target management system for managing attached targets using electronic tags respectively attached to the attached targets, the electronic tag attached target management system comprising
a data writing apparatus for recording a serial number in each of the electronic tags and for recording a flag in at least one of the electronic tags, the serial numbers being consecutive numbers, the total number of attached targets being able to be calculated by means of the flag.

60. The electronic tag attached target management system as claimed in claim 59, wherein the data writing apparatus is a handy type electronic tag reader/writer.

61. The electronic tag attached target management system as claimed in claim 59, wherein the data writing apparatus is an electronic tag reader/writer for controlling radio waves to be transmitted and received via at least one antenna, and the at least one antenna is attached to an arm of a gate mechanism slidably up and down and/or right and left in order to record data in the electronic tags attached to the attached targets, the attached targets being caused to path through the gate mechanism.

62. The electronic tag attached target management system as claimed in claim 61, wherein the total number of attached targets and the respective attached targets corresponding to the serial numbers are specified by reading the serial numbers and the flag recorded in the electronic tags by means of the data writing apparatus.

63. The electronic tag attached target management system as claimed in claim 62, wherein the total number of attached targets can be specified on the basis of the serial numbers and the flags recorded in the electronic tags from each of which the serial number and the flag can be read even in the case where there is any electronic tag from which data recorded in the electronic tag cannot be read by means of the data writing apparatus.

64. The electronic tag attached target management system as claimed in claim 63, wherein the number of electronic tags, from which data cannot be read, can be specified on the basis of the serial numbers and the flags recorded in the electronic tags from each of which the serial number and the flag can be read even in the case where there is any electronic tag from which data recorded in the electronic tag cannot be read by means of the data writing apparatus.

65. The electronic tag attached target management system as claimed in claim 64, wherein the attached targets corresponding to the electronic tags, from which data cannot be read, can be specified on the basis of the serial numbers and the flags recorded in the electronic tags from each of which the serial number and the flag can be read even in the case where there is any electronic tag from which data recorded in the electronic tag cannot be read by means of the data writing apparatus.

66. The electronic tag attached target management system as claimed in claim 65, further comprising
an electronic tag reader/writer for controlling radio waves to be transmitted and received via the at least one antenna wherein the at least one antenna is attached to the arm of the gate mechanism for causing the attached targets to pass therethrough in order to carry out management of the attached targets.

67. The electronic tag attached target management system as claimed in claim 66, wherein consecutive numbers starting from one are in turn recorded in the respective electronic tags as the serial numbers, and the total number of attached targets is recorded in all of the electronic tags as the flag.

68. The electronic tag attached target management system as claimed in claim 66, wherein consecutive numbers starting from an arbitrary number are in turn recorded in the respective electronic tags as the serial numbers, and as the flags, a start flag indicating the first is recorded in the electronic tag attached to a first attached target of the attached targets and an end flag indicating the last is recorded in the electronic tag attached to a last attached target of the attached targets.

69. The electronic tag attached target management system as claimed in claim 66, wherein consecutive numbers starting from an arbitrary number are in turn recorded in the respective electronic tags as the serial numbers, and the total number of attached targets is recorded in the electronic tag attached to a last attached target of the attached targets as the flag.

70. The electronic tag attached target management system as claimed in claim 66, wherein consecutive numbers starting from one are in turn recorded in the respective electronic tags as the serial numbers, and an end flag indicating the last is recorded in the electronic tag attached to a last attached target of the attached targets as the flag.

71. The electronic tag attached target management system as claimed in claim 70, wherein consecutive numbers are in turn recorded in the respective electronic tags of rows or columns in which the respective attached targets exist as the serial number, and row numbers or column numbers capable of specifying the rows or the columns in which the respective attached targets exist are further recorded as the flag.

72. An electronic tag attached target management system for managing attached targets using electronic tags respectively attached to the attached targets, the electronic tag attached target management system comprising a data writing apparatus, the data writing apparatus comprising:
means for generating first miss-in-reading preventing information and for storing it in the electronic tag, and
means for determining a miss in reading by comparing the first miss-in-reading preventing information read from the electronic tag with second miss-in-reading preventing information generated from information read from the electronic tag.

73. The electronic tag attached target management system as claimed in claim 59, wherein the data writing apparatus comprises:
means for generating first miss-in-reading preventing information and for storing it in the electronic tag; and
means for determining a miss in reading by comparing the first miss-in-reading preventing information read from the electronic tag with second miss-in-reading preventing information generated from information read from the electronic tag.

74. The electronic tag attached target management system as claimed in claim 73, wherein the miss-in-reading preventing information is hash data created from the information read from the electronic tag by means of hash algorithm.

75. An article management system for managing articles using RFID tags attached to the respective articles, the article management system comprising
a data writing apparatus for recording a serial number in each of the RFID tags and for recording a flag in at least one of the RFID tags, the serial numbers being consecutive numbers, the total number of articles that become management targets of the articles being able to be calculated by means of the flag.

76. The article management system as claimed in claim 75, wherein the data writing apparatus is a handy type RFID tag reader/writer.

77. The article management system as claimed in claim 75, wherein the data writing apparatus is an RFID tag reader/writer for controlling radio waves to be transmitted and received via at least one antenna, and the at least one antenna is attached to an arm of a gate mechanism slidably up and down and/or right and left in order to record data in the RFID tags attached to the articles of the management targets, the articles being caused to path through the gate mechanism.

78. The article management system as claimed in claim 77, wherein the total number of articles of the management targets and the respective articles corresponding to the serial numbers can be specified by reading the serial numbers and the flag recorded in the RFID tags by means of the data writing apparatus.

79. The article management system as claimed in claim 78, wherein the total number of articles of the management targets is specified on the basis of the serial numbers and the flags recorded in the RFID tags from each of which the serial number and the flag can be read even in the case where there is any RFID tag from which data recorded in the RFID tag cannot be read by means of the data writing apparatus.

80. The article management system as claimed in claim 79, wherein the number of RFID tags, from which data cannot be read, is specified on the basis of the serial numbers and the flags recorded in the RFID tags from each of which the serial number and the flag can be read even in the case where there is any RFID tag from which data recorded in the RFID tag cannot be read by means of the data writing apparatus.

81. The article management system as claimed in claim 80, wherein, in the article inspection apparatus, the articles corresponding to the RFID tags, from which data cannot be read, are specified on the basis of the serial numbers and the flags recorded in the RFID tags from each of which the serial number and the flag can be read even in the case where there is any RFID tag from which data recorded in the RFID tag cannot be read by means of the data writing apparatus.

82. The article management system as claimed in claim 81, further comprising
an RFID tag reader/writer for controlling radio waves to be transmitted and received via at least one antenna wherein the at least one antenna is attached to an arm of a gate mechanism for causing the articles to pass therethrough in order to carry out inspection on the articles of the management targets.

83. The article management system as claimed in claim 82, wherein consecutive numbers starting from one are in turn recorded in the respective RFID tags as the serial numbers, and the total number of articles of the management targets is recorded in all of the RFID tags as the flag.

84. The article management system as claimed in claim 82, wherein consecutive numbers starting from an arbitrary number are in turn recorded in the respective RFID tags as the serial numbers, and as the flags, a start flag indicating the first is recorded in the RFID tag attached to a first article and an end flag indicating the last is recorded in the RFID tag attached to a last article.

85. The article management system as claimed in claim 82, wherein consecutive numbers starting from an arbitrary number are in turn recorded in the respective RFID tags as the serial numbers, and the total number of articles of the management targets is recorded in the RFID tag attached to a last article of the articles of the management targets as the flag.

86. The article management system as claimed in claim 82, wherein consecutive numbers starting from one are in turn recorded in the respective RFID tags as the serial numbers, and an end flag indicating the last is recorded in the RFID tag attached to a last article of the articles of the management targets as the flag.

87. The article management system as claimed in claim 86, wherein consecutive numbers are in turn recorded in the respective RFID tags of rows, columns or clusters in which the respective attached targets exist as the serial number, and row numbers, column numbers or cluster numbers capable of specifying the rows, the columns or the clusters in which the respective attached targets exist are further recorded as the flag.

88. A lending management system for managing lending using RFID tags attached to respective lending target articles, the lending management system comprising
a data writing apparatus for recording serial numbers that are consecutive numbers in the respective RFID tags, and for recording a flag in at least one of the RFID tags, the total number of articles that become management targets being able to be calculated by means of the flag.

89. The lending management system as claimed in claim 86, wherein consecutive numbers starting from an arbitrary number are in turn recorded in the respective RFID tags as the serial numbers, and as the flags, a start flag indicating the first is recorded in the RFID tag attached to a first article of the articles of the management targets and an end flag indicating the last is recorded in the RFID tag attached to a last article of the articles of the management targets.

90. An entering and leaving management system for managing entering and leaving in an institution using RFID tags attached to respective visitors, the entering and leaving management system comprising:
a data writing apparatus for recording a serial number in each of the RFID tags and for recording a flag therein, the serial numbers being consecutive numbers, the total number of articles that become management targets being able to be calculated by means of the flag.

91. The entering and leaving management system as claimed in claim 90, wherein consecutive numbers starting from an arbitrary number are in turn recorded in the respective RFID tags as the serial numbers, and as the flags, a start flag indicating the first is recorded in the RFID tag attached to a first visitor of management subjects and an end flag indicating the last is recorded in the RFID tag attached to a last visitor of the management subjects.

92. An article management method of managing articles using RFID tags attached to the respective articles, the article management method comprising:
recording a serial number in each of the RFID tags, the serial numbers being consecutive numbers; and
recording a flag in at least one of the RFID tags, the total number of articles that become management targets of the articles being able to be calculated by means of the flag.

93. The article management method as claimed in claim 92, wherein the total number of articles of the management targets and the respective articles corresponding to the serial numbers can be specified by reading the serial numbers and the flags recorded in the RFID tags by means of the data writing apparatus when the articles are inspected.

94. The article management method as claimed in claim 93, wherein the total number of articles of the management targets can be specified on the basis of the serial numbers and the flags recorded in the RFID tags from each of which the serial number and the flag can be read even in the case where there is any RFID tag from which data recorded in the RFID tag cannot be read by means of the data writing apparatus when the articles are inspected.

95. The article management method as claimed in claim 94, wherein the number of RFID tags, from which data cannot be read, can be specified on the basis of the serial numbers and the flags recorded in the RFID tags from each of which the serial number and the flag can be read even in the case where there is any RFID tag from which data recorded in the RFID tag cannot be read by means of the data writing apparatus when the articles are inspected.

96. The article management method as claimed in claim 95, wherein the articles corresponding to the RFID tags, from which data cannot be read, can be specified on the basis of the serial number and the flag recorded in the RFID tag from which the serial number and the flag can be read even in the case where there is any RFID tag from which data recorded in the RFID tag cannot be read by means of the data writing apparatus when the articles are inspected.

97. The article management method as claimed in claim 96, wherein consecutive numbers starting from one are in turn recorded in the respective RFID tags as the serial numbers, and the total number of articles of the management targets is recorded in all of the RFID tags as the flag.

98. The article management method as claimed in claim 96, wherein consecutive numbers starting from an arbitrary number are in turn recorded in the respective RFID tags as the serial numbers, and as the flags, a start flag indicating the first is recorded in the RFID tag attached to a first article and an end flag indicating the last is recorded in the RFID tag attached to a last article.

99. The article management method as claimed in claim 96, wherein consecutive numbers starting from an arbitrary number are in turn recorded in the respective RFID tags as the serial numbers, and the total number of articles of the management targets is recorded in the RFID tag attached to a last article of the articles of the management targets as the flag.

100. The article management method as claimed in claim 96, wherein consecutive numbers starting from one are in turn recorded in the respective RFID tags as the serial numbers, and an end flag indicating the last is recorded in the RFID tag attached to a last article of the articles of the management targets as the flag.

101. The article management method as claimed in claim 100, wherein consecutive numbers are in turn recorded in the respective RFID tags of rows, columns or clusters in which the respective attached targets exist as the serial number, and row numbers, column numbers or cluster numbers capable of specifying the rows, the columns or the clusters in which the respective attached targets exist are further recorded as the flag.

102. A lending management method of managing lending using RFID tags attached to respective lending target articles, the lending management method comprising:
recording serial numbers that are consecutive numbers in the respective RFID tags; and
recording a flag in at least one of the RFID tags, the total number of articles that become management targets being able to be calculated by means of the flag.

103. The lending management method as claimed in claim 101, wherein consecutive numbers starting from an arbitrary number are in turn recorded in the respective RFID tags as the serial numbers, and as the flags, a start flag indicating the first is recorded in the RFID tag attached to a first article of the articles of the management targets and an end flag indicating the last is recorded in the RFID tag attached to a last article of the articles of the management targets.

104. An entering and leaving management method of managing entering and leaving in an institution using RFID tags attached to respective visitors, the entering and leaving management method comprising:
recording a serial number in each of the RFID tags, the serial numbers being consecutive numbers; and
recording a flag therein, the total number of articles that become management targets being able to be calculated by means of the flag.

105. The entering and leaving management method as claimed in claim 104, wherein consecutive numbers starting from an arbitrary number are in turn recorded in the respective RFID tags as the serial numbers, and as the flags, a start flag indicating the first is recorded in the RFID tag attached to a first visitor of management subjects and an end flag indicating the last is recorded in the RFID tag attached to a last visitor of the management subjects.

106. A method of preventing a miss in reading, the method comprising:
a first step of generating miss-in-reading preventing information;
a second step of storing the generated miss-in-reading preventing information in an RFID tag attached to an inspection target object;
a third step of acquiring a pair of all tag IDs belonging to the same lot and the stored miss-in-reading preventing information for every lot;
a fourth step of creating a first list, the first list having the pair of the acquired all tag IDs and the acquired miss-in-reading preventing information as elements;
a fifth step of acquiring one piece of miss-in-reading preventing information from the first list;
a sixth step of extracting an element having the same miss-in-reading preventing information as the acquired miss-in-reading preventing information from the first list and of creating a second list having a tag ID as an element, the tag ID pairing with the extracted miss-in-reading preventing information;
a seventh step of calculating the miss-in-reading preventing information on the basis of the second list; and
an eighth step of checking and comparing the acquired miss-in-reading preventing information with the calculated miss-in-reading preventing information and of determining that all of the tags stored in the second list and the articles of an assigned lot get together in the case that they are equal to each other.

107. The method as claimed in claim 106, wherein the processes from the fifth step to the eighth step are repeatedly carried out until there becomes no elements stored in the first list.

108. An electronic tag used with a predetermined number of lots, the electronic tag comprising
a first storage section that stores first information for identifying whether the predetermined number of lots exist or not.

109. The electronic tag as claimed in claim 108, wherein the first information is hash data generated from IDs of the predetermined number of electronic tags.

110. The electronic tag as claimed in claim 108, further comprising
a second storage section that stores second information for identifying the electronic tag.

111. The electronic tag as claimed in claim 110, wherein the second information is a consecutive number starting from a predetermined number set to each of the predetermined number of electronic tags, and the first information is the predetermined number.

112. The electronic tag as claimed in claim 110, wherein the second information is a consecutive number starting from a predetermined number set to each of the predetermined number of electronic tags, and the first information in a last electronic tag of the predetermined number of electronic tags is an end flag.

113. The electronic tag as claimed in claim 110, wherein the second information is a consecutive number starting from an arbitrary number set to each of the predetermined number of electronic tags, the first information in a first electronic tag of the predetermined number of electronic tags is a start flag, and the first information of a last electronic tag is an end flag.

114. The electronic tag as claimed in claim 110, wherein the second information is a consecutive number starting from an arbitrary number set to each of the predetermined number of electronic tags, and the first information in a last electronic tag of the predetermined number of electronic tag is the predetermined number.

115. The electronic tag as claimed in claim 110, wherein the second information is a consecutive number for each of rows or columns in which attached targets of the predetermined number of electronic tags exist, and the first information is information for identifying the row or the column in which the attached targets of the predetermined number of electronic tags exist.

116. The electronic tag as claimed in claim 115, further comprising
a third storage section that stores a hash value generated from an ID of the predetermined number of electronic tags.
